(19) United States
(12) Patent Application Publication
(10) Pub. No.: US 2013/0332313 A1
(43) Pub. Date: Dec. 12, 2013

(54) Electronic Marketplace For Commercial Real Estate

(71) Applicant: Andrew Bermudez, Fullerton, CA (US)

(72) Inventor: Andrew Bermudez, Fullerton, CA (US)

(21) Appl. No.: 13/914,537

(22) Filed: Jun. 10, 2013

Related U.S. Application Data
(60) Provisional application No. 61/657,507, filed on Jun. 8, 2012.

(51) Int. Cl. G06Q 30/06; G06Q 50/16

(52) U.S. Cl. CPC G06Q 30/0613; G06Q 50/16
USPC 705/26.41

(57) ABSTRACT

A system facilitates commercial real estate transactions by providing a first electronic interface through which a first broker can post real estate requirements, a second electronic interface through which a second broker can post real estate availabilities, and a facility that finds a match among the requirements and the availabilities, and notifies at least one of the first and second brokers of the match. Preferred systems can match requirements and availabilities based upon multiple factors, including deal terms, type of real estate, and timing, and can use fuzzy logic. Preferred systems can also include automatically notifying relevant brokers upon entry of a new availability of requirement listing. and can make matching recommendations.

This application claims priority to U.S. provisional patent application Ser. No. 61/657,507 filed Jun. 8, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is electronic marketplaces for real estate.

### BACKGROUND

Communication between real estate brokers can be particularly cumbersome. For example, it can take numerous phone calls to simply get a hold of local brokers, or brokers in other markets. Moreover, matters can become even more complicated when one considers the scheduling conflicts that can occur between brokers involved in negotiations. Overall, a lack of online communication can be very costly for a commercial real estate broker due to lost time and additional administrative costs.

Online commercial real estate listings are available, but (1) they are generally limited to listing property availabilities, and (2) other than providing contact information for the listing broker, they do not facilitate communications between brokers or between brokers and their clients.

Thus, there is still a need for an online commercial real estate marketplace that (1) lists both property availabilities and requirements, and (2) facilitates communications between brokers and between brokers and their clients.

### SUMMARY OF THE INVENTION

The inventive subject matter provides apparatus, systems and methods in which a system facilitates commercial real estate transactions by providing a first electronic interface through which a first broker can post real estate requirements, a second electronic interface through which a second broker can post real estate availabilities, and a facility that finds a match among the requirements and the availabilities, and notifies at least one of the first and second brokers of the match.

As used herein, the term “facility” means a physical device comprising electronics programmed or otherwise configured to (a) perform a desired function or (b) provide access to a device, system or service that performs the desired function. Facilities can be stand-alone, networked and/or implemented in cloud computing or other distributed environments.

Throughout the application, references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

In one aspect of preferred embodiments, the system matches the requirements and availabilities based upon multiple factors, including deal terms, type of real estate, and timing. In especially preferred embodiments, the match is based on logic that does not require exact matching of terms (fuzzy logic).

In another aspect of preferred embodiments, the system acts as a Customer Relationship Management (CRM) system, which can include automatically notifying relevant brokers upon entry of a new availability of requirement listing. In especially preferred embodiments, the system can limit the notification in a specified manner, including for example limiting notification to the lister's agency, to some other company, and/or to a particular subset of the relevant brokers. It is also contemplated that the system could log activities associated with a client, availability and/or requirement listing, and generate an activity report.

In yet another aspect, preferred systems can make recommendations, including for example recommendations of availability listings that match a current requirements listing, and/or recommendations of requirements listings that match a current availability listing.

In yet another aspect, access to the system can advantageously be limited in some manner. Among other things, access could be limited to a particular group of people, such as commercial real estate brokers, or by vetting new users by a human administrator.

In yet another aspect of preferred embodiments, the system can automatically interact with other systems, including for example, notifying a multiple listing service (MLS) upon entry of a new listing.

### BRIEF DESCRIPTION OF THE DRAWINGS

FIG. 1 is a screen shot of a home page of an exemplary embodiment of the inventive subject matter.

FIG. 2 is a screen shot of a user profile page.

FIG. 3 is a screen shot of a requirements list page.

FIG. 4 is a screen shot of a requirements profile page.

FIG. 5 is a screen shot of an interface from which a user can send an email.

FIG. 6 is a screen shot of an interface from which a user can attach files.

FIG. 7 is a screen shot of a posting requirements page.

FIG. 8 is a screen shot of a posting requirement form.

FIGS. 9 and 10 are screen shots of interfaces use to send out emails to designated brokers to notify them of new real estate requirement postings.

FIG. 11 is a screen shot of an exemplary embodiment of a “My Listings” page.

FIG. 12 is a screen shot of an exemplary embodiment of an availability profile page.

FIG. 13 is a screen shot of an exemplary embodiment of a prospects section.

FIG. 14 is a screen shot of an exemplary embodiment of an interface for adding a prospect by use of a “+New Prospect” button.

FIG. 15 is a screen shot of an exemplary embodiment of an availability prospect page.

FIG. 16 is a screen shot of an exemplary embodiment of an interface where a user can email the prospect information and log an activity into associated with the prospect.

FIG. 17 is a screen shot of an exemplary embodiment of an “Activities” section that shows a user a history record of all of the logged activities with various prospects.

FIG. 18 is a screen shot of an exemplary embodiment of a property profile page that allows a user to see all of the currently active availability listings a user has associated with a property.

FIG. 19 is a screen shot of an exemplary embodiment of an interface through which a user can share and email these files directly through the Property Profile Page.

FIG. 20 is a screen shot of an exemplary embodiment of a form that can be used to create an available listing.

FIG. 21 is a screen shot of an exemplary embodiment of an email that can be sent out to all registered users and list in the “Master Database of Possible Users”, which summarizes all of the real estate requirements posted by users in their market.

### DETAILED DESCRIPTION

In general, brokers (or other users) input both real estate availabilities and requirements, including for example lease, purchase, and/or investment details. The system then automatically matches availabilities with requirements, and notifies the listing brokers. Matches are preferably based on factors including deal terms, real estate and timing. Where no exact match exists, the system can make recommendations, whether the recommendation is for the broker's own listing or some a different broker's listing.

In another aspect, contemplated systems utilize CRM-type functionalities, including maintaining contact lists of clients, prospects and other brokers, automating emailing or other messaging among brokers and clients, restriction of postings and/or communications to a limited distributions, and generating activity reports for property owners and clients.

Preferred embodiments limit registration. One way of doing that is with white-lists of email domains (e.g., “cbre.com”). In such embodiments, if a user tries to register with an email domain that is not on the white-list, the registration is denied and the user is informed that the website is exclusive and they need to apply for access. Alternatively, a master database can be kept with all the possible users in a market. Therefore, when new user registers and the email address used to register matches the email address of a record in the master database of all possible users the user claims that record as their own. However, if someone has already claimed the record, the user is issued a warning and the registration is cancelled. Finally, it is further contemplated that every user is forced to confirm their registration via email such that if the registration is not confirmed, the user is denied access. In this way, registration of the broker with the system can be limited according to a white list, a black list, and/or vetting by a human administrator.

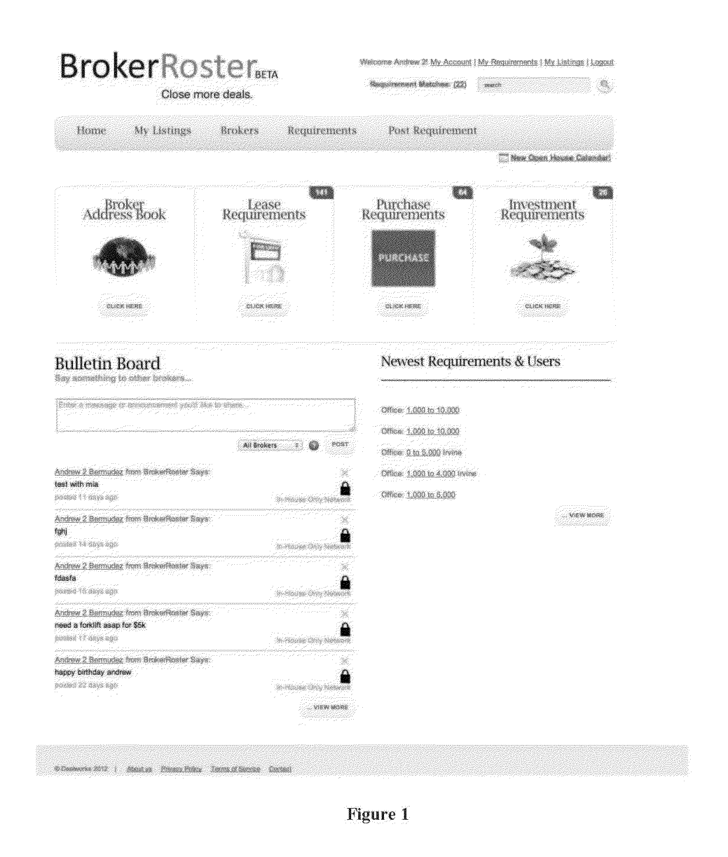

An exemplary embodiment of the inventive subject matter is illustrated in FIG. 1 where a homepage informs the user of the information in the system. Such information may be organized as displayed in FIG. 1 or in another orientation with alternative factors. The home page may contain the following: (1) a “broker address book” that lets a user quickly access contact information for in their market; (2) a lease requirements section that displays how many active lease real estate requirements are posted by other users in their market with a red icon showing the number of active posts; (3) a purchase requirements section that displays how many active purchase real estate requirements are posted by other users in their market with a red icon showing the number of active posts; (4) a investment requirements section that displays how many active investment real estate requirements are posted by other users in their market with a red icon showing the number of active posts; (5) a bulletin board section that allows a user to see and reply to any of the bulletin posts that other users have posted and further wherein a “lock” icon next to the bulletin post means that the information is only viewable by users that work for the same company; (6) a newest requirements and users section that shows a user all of the most recent commercial real estate requirements that have been posted and the most recent new users; (7) a requirement matches link at the top of the screen that tells a user the number of currently posted active lease, purchase and investment requirements that match the user's active availability listings; and/or (8) a open house calendar link below the navigation bar that allows a user to see all of the open house events happening in their market.

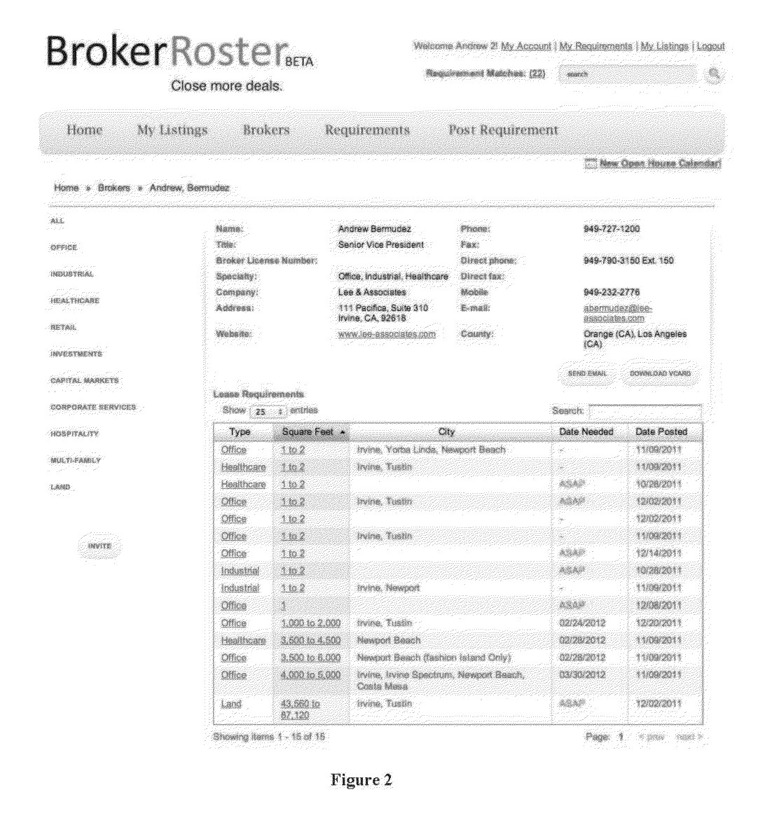

FIG. 2 illustrates a user profile page. When viewing a user's and/or broker's profile page, contact information may be demonstrated as displayed in FIG. 2, where a user can see active lease, purchase and investment real estate requirements that are currently posted.

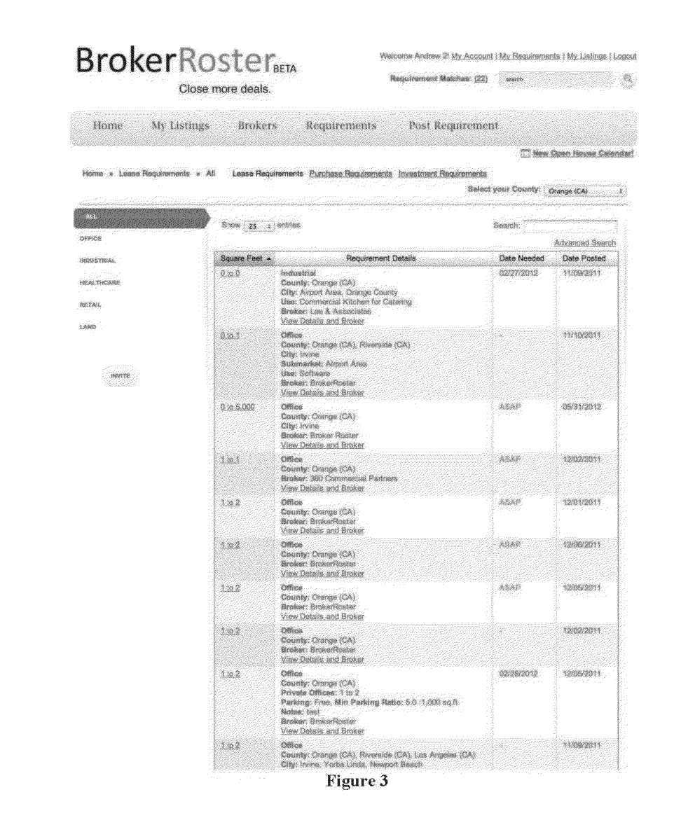

FIG. 3 is an exemplary embodiment of a requirement list view wherein all posted real estate requirements are shown in a list view. A user can filter the real estate requirements list by the type of property by clicking the property type filter on the left-hand side of the screen (e.g., office, industrial, healthcare, retail, and/or land). Additionally, clicking the “view details and broker” link can take the user to the requirement profile view page.

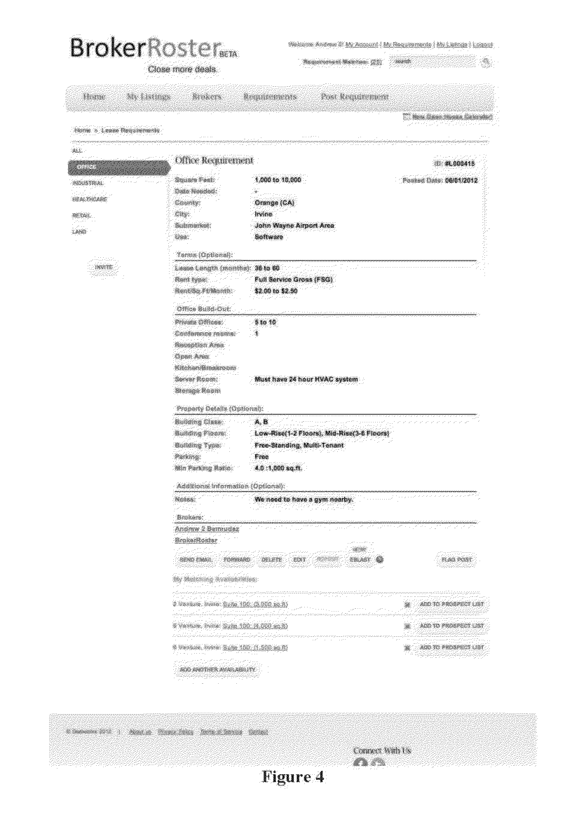

FIG. 4 is an exemplary embodiment of a requirement profile view page. In this page, a user can view all of the details of the posted real estate requirement. It is further contemplated that the system automatically tell the user which of their availability listings match the real estate requirement below the details and contact information of the broker who posted the real estate requirement (see “My Matching Availabilities” section of FIG. 4). Additionally, the system also lets a user manually add an availability listing that is not automatically shown, but that the user think will match. Within the “My Matching Availabilities” section, it is contemplated that at least one of the following functions can be performed: (1) clicking the “x” removes the matching Availability Listing, so that the user doesn't have to see it again; and/or (2) clicking the “Add to Prospect List” button adds the real estate requirement and broker who posted it to the prospect list of the matching availability listing.

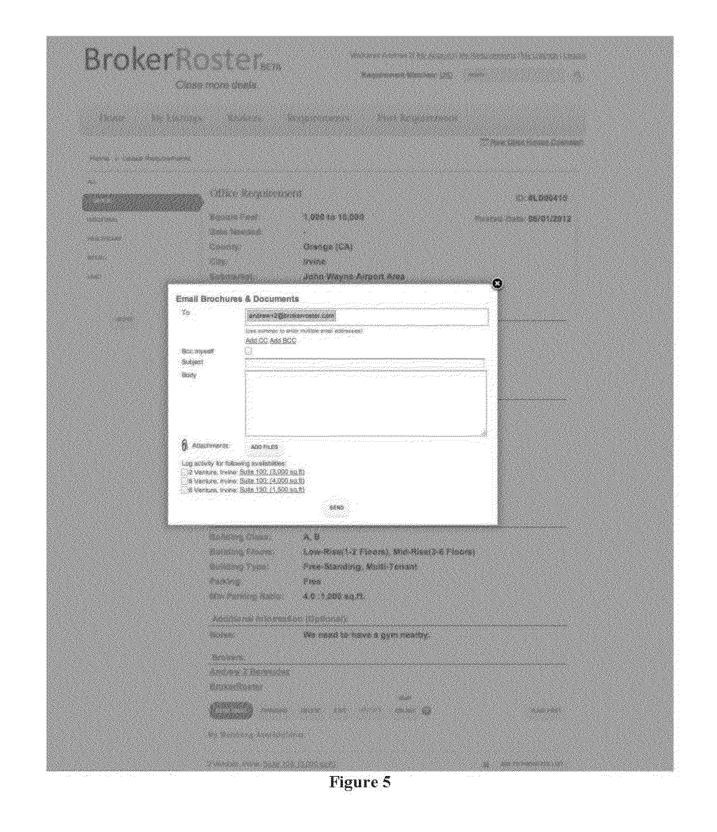

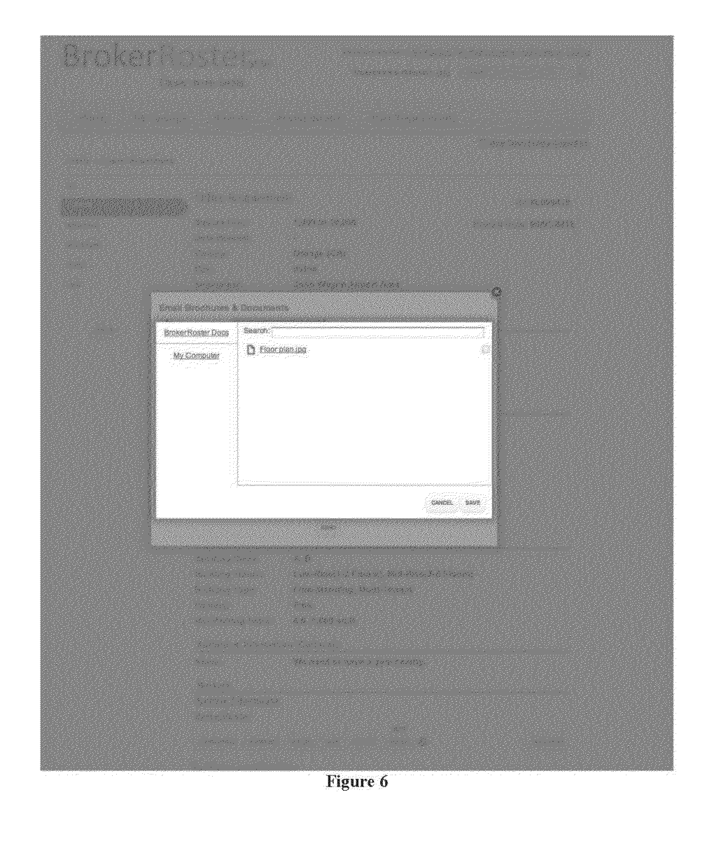

FIG. 5 is an exemplary embodiment of a requirement profile view sending an email. A user can respond to a real estate requirement posting by clicking the “Send Email” button. When sending an email response, the user can check a box in the “Log activity for following availabilities” section to convert the broker who they are responding to into a prospect for the checked availability listing and log an activity in the activity report for that availability listing. Furthermore, a user can also add file attachments to the email they are sending. For example, a user can attach files from their computer or those that they have uploaded to their cloud storage and/or network storage as illustrated in FIG. 6.

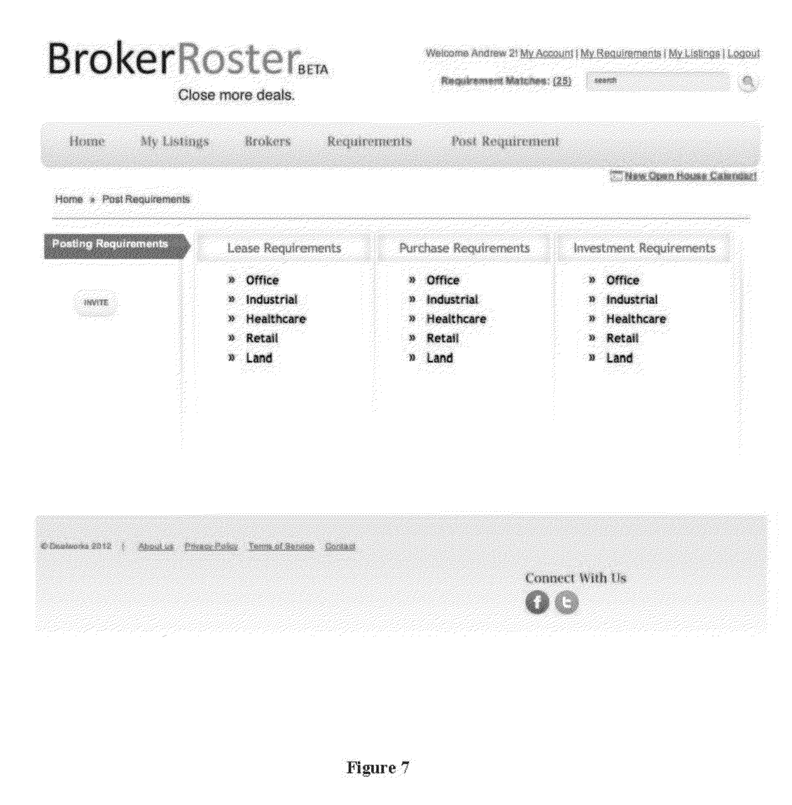

FIG. 7 shows posting requirements wherein a user can post a lease, purchase or investment real estate requirement. When posting a real estate requirement the user can pick the following of real estate requirement they are posting (e.g., lease, purchase and/or investment). Moreover, the user can then pick the type of property they are posting a lease, purchase or investment real estate requirement for (e.g., office, industrial, healthcare, retail, and/or land). Finally, after making their selections, the user can be taken to the posting requirement form.

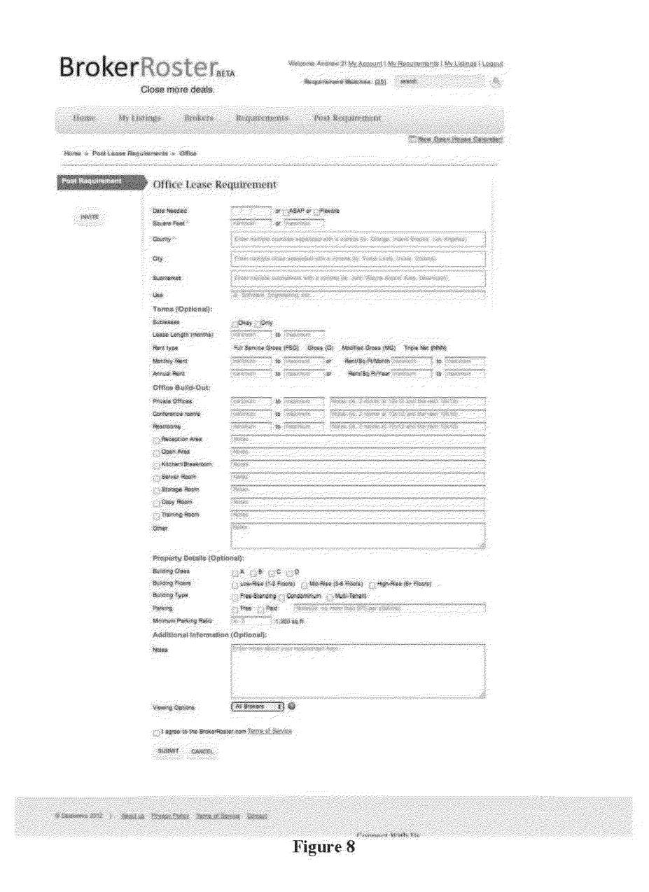

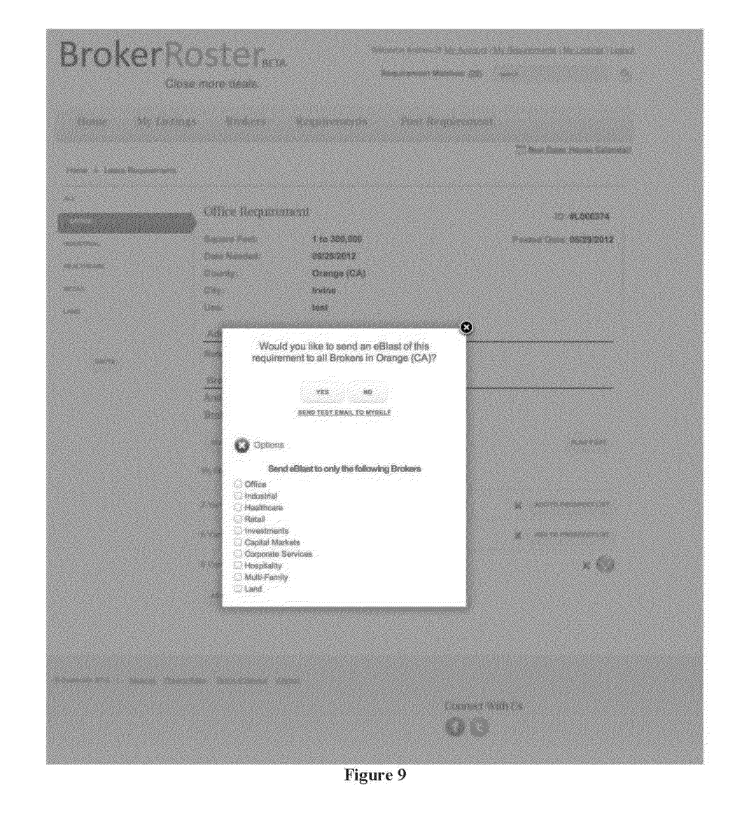

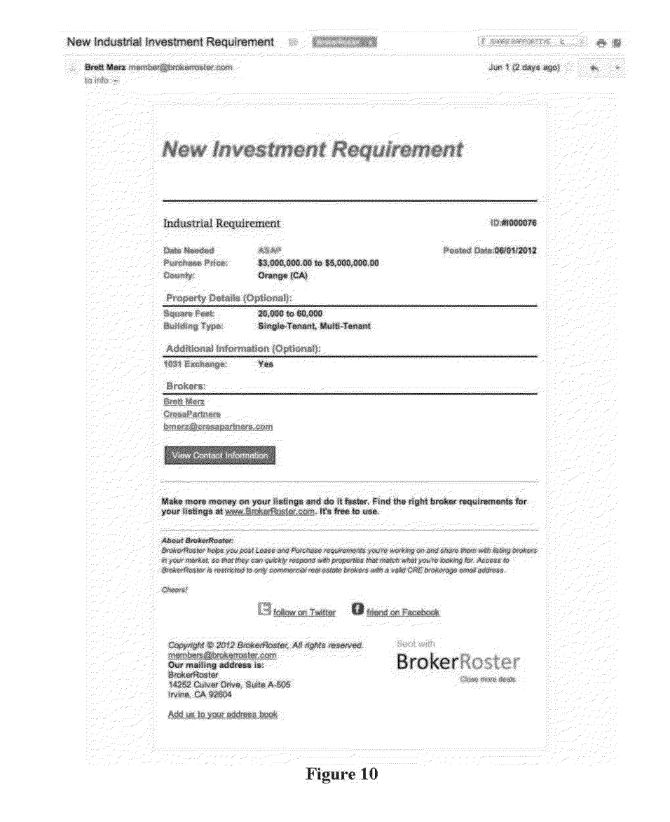

An exemplary embodiment of a posting requirement form is illustrated in FIG. 8. It is contemplated that the user is given a form that is specifically tailored for the type of requirement that is being posted based on the type of real estate requirement and the type of property a user selects when posting a requirement. Moreover, the user can selectively tailor the viewing options of the post. For example, the “viewing options” drop-down field in the real estate requirement posting form can allow a user to select whether the user wants the requirement posting to be visible to every broker in their market, or restrict the visibility to only brokers who work for their same company. Furthermore, it is contemplated that after a user posts a real estate requirement, a window can automatically appear that allows the user to be able to send out a mass email (“eBlast”) to all brokers in their market (or only brokers in their company) to notify them that he/she has posted a new real estate requirement as illustrated in exemplary embodiments in FIGS. 9 and 10.

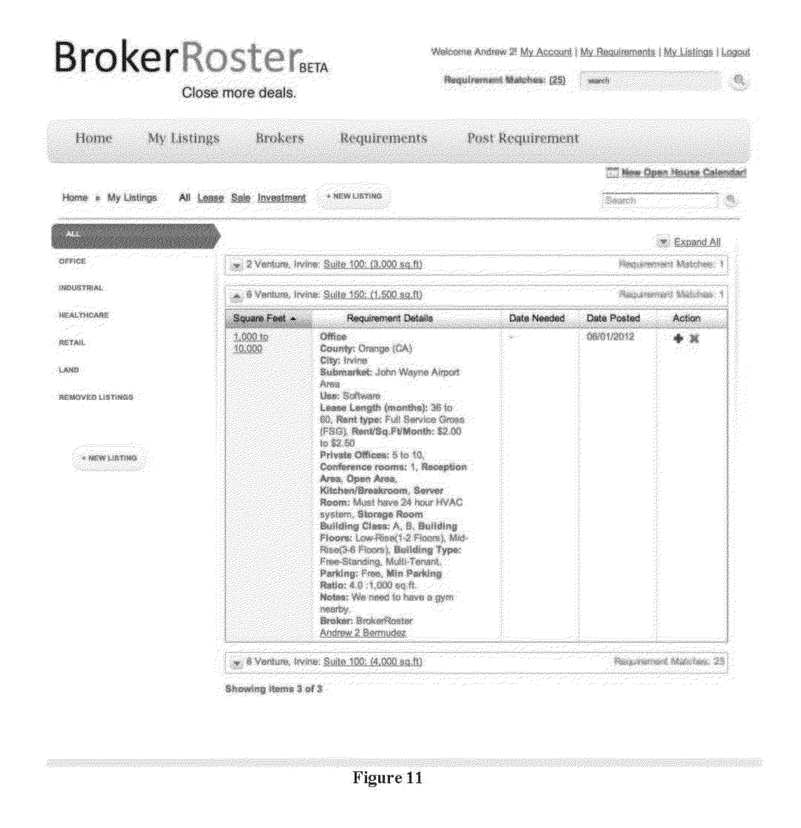

FIG. 11 illustrates an exemplary embodiment of a “My Listings” page that shows the user's active availability listings that have been actively listed by the user and/or a system administrator. In such page, a user can filter each of their availability listings by the type of property by clicking the property type filter on the screen (e.g., all, office, industrial, healthcare, retail, land, and/or removed listing s). Additionally, the user can search his/her own availability listings based on property address, suite number, pricing, property type and including tenant improvement floor plan build-out. Each availability listing can show the number of real estate requirements posted by other users and principal prospects created by the user that match each one of the user's availability listings. Finally, it is contemplated that the “+” button lets a user add the matching requirement to the prospect list of the matching availability listing and the “x” button lets a user remove the matching requirement so that: (1) they don't see it again; and (2) the user can log the removal activity to the activity report of the prospect list of the matching availability listing.

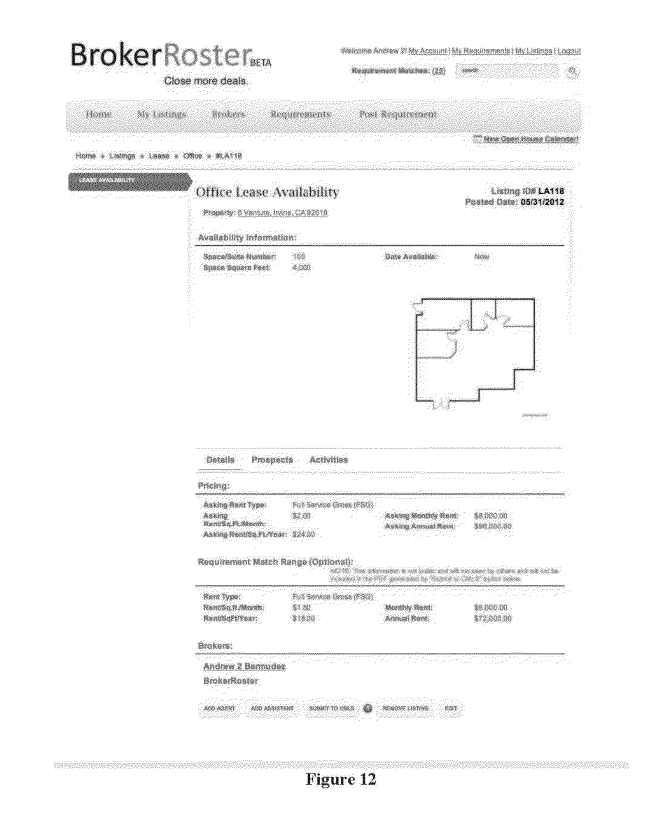

FIG. 12 is an exemplary embodiment of an availability profile page wherein the page can show a user all of the details of an availability listing they have created. The “Details” section can show the user the property address, suite number, square feet size, date of availability, floor plans, pricing, tenant improvement floor plan build-out information and any other details associated with the availability. Furthermore, it is contemplated that the user can see the defined price range that a real estate requirement posting must meet in order to match (see generally, “Requirement Match Range” section of the availability profile page in FIG. 12). In addition, a user can also: (1) share access to an availability listing with other agents or assistants in their company, so that they can edit, manage and collaborate on the availability listing; (2) submit/syndicate the availability listing information to all real estate multiple listing services (MLS) by clicking the “Submit to CMLS” button; and/or (3) remove an availability listing and submit/syndicate the removal of the availability listing to all real estate multiple listing Services (MLS) by clicking the “Remove Listing” button. In further preferred embodiments, a user can access a prospects section from the availability profile page (see prospects tab in FIG. 12).

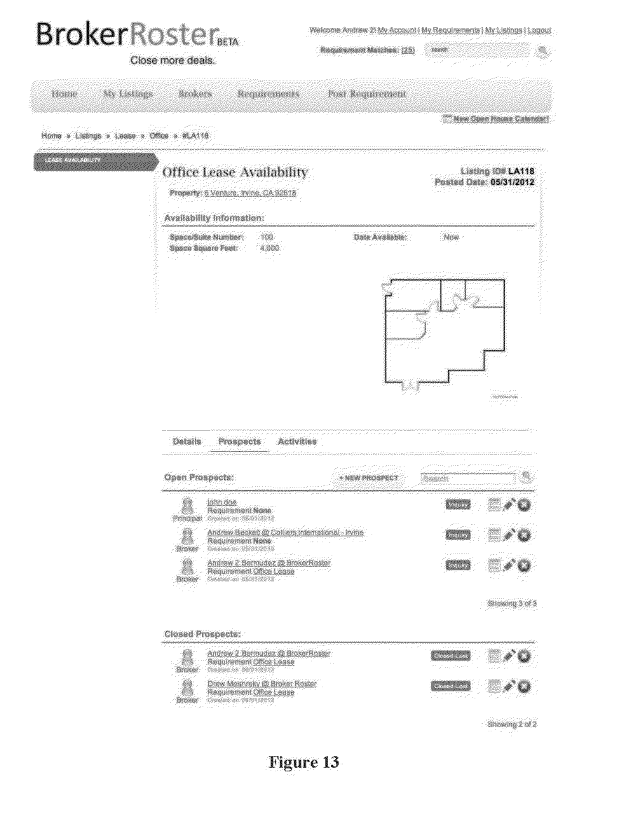

An exemplary embodiment of a prospects section is illustrated in FIG. 13. In this prospects page, a user can access the following: (1) all of the principal/brokers they have added as “prospects”; (2) all of the broker/principal “Prospects” they have created manually by pressing the “+New Prospect” button; and (3) the “stage” that each prospect is in (e.g., inquiry, scheduled tour, negotiation, closed-won and/or closed-lost). A user can add a prospect by a plurality of forms. For example, a prospect can be added by (1) pressing the “+” button of matching requirements in the “My Listings Page”; (2) pressing the “Add to Prospect List” in any real estate requirement posting or matching availability section of any page; and/or (3) sending an email and choosing to create a prospect and log an activity. Furthermore, a user can manually create “prospects” by clicking the “+New Prospect” button in the prospects section.

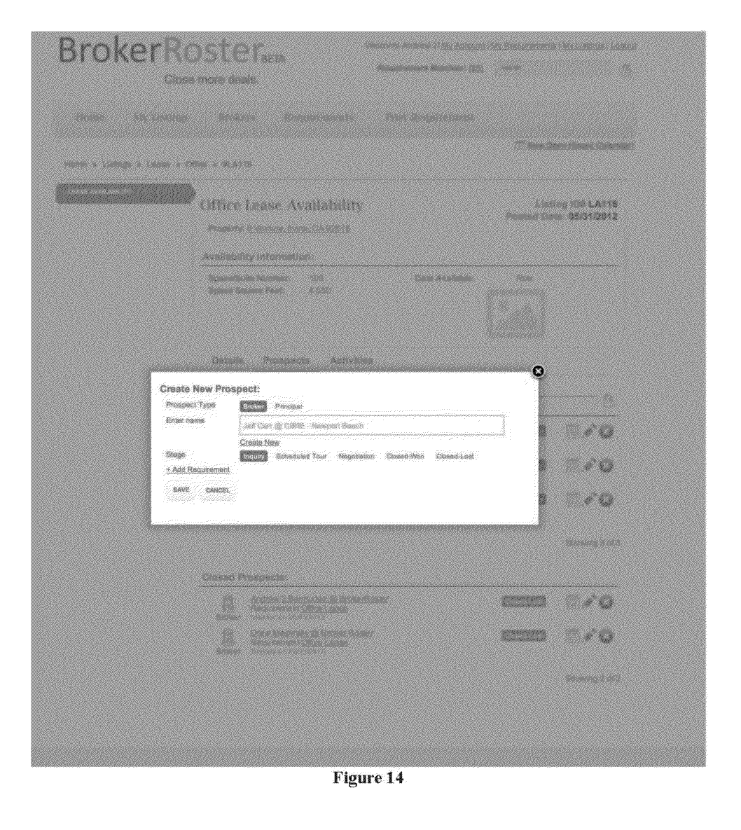

An exemplary embodiment of adding a prospect by use of the “+New Prospect” button is illustrated in FIG. 14. Prospects can be differentiated into brokers and/or principals. When creating a “Broker” prospect and the user starts typing the name of the prospect, the system can automatically auto-populate the contact information of the prospect if they already exist in the system as a user, or a broker prospect previously created by the user creating the prospect. Alternatively, when creating a “Principal” prospect and the user can starts by typing the name of the prospect, the system can automatically auto-populate the contact information of the principal prospect previously created by the user. However, if no information matches, the system automatically expands additional contact fields for the user to create a new prospect. When creating a broker or principal prospect, the user can click the “+Add Requirement” link to add real estate requirement information associated with the prospect. This information can be private to the user adding the information. In other words, no other user in the system can see this information, except for other users whom have been added to the availability listing as “Added Agents” or “Added Assistants”.

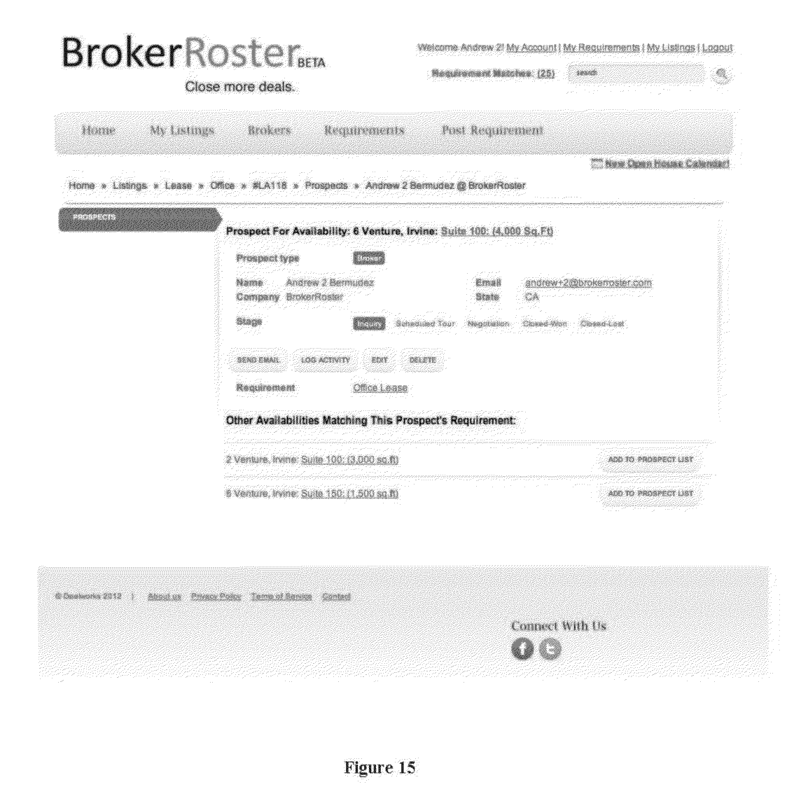

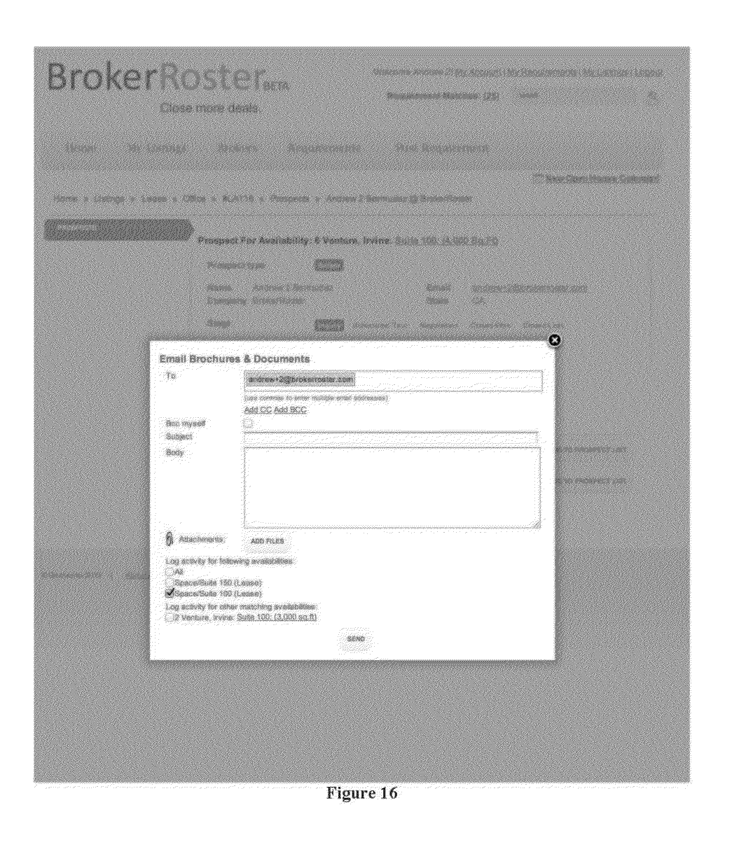

After creating/adding a prospect, an availability prospect page can shows a user the following information (as illustrated in FIG. 15 as an exemplary embodiment): (a) all of the contact information associated with the prospect the user created; (b) the “Stage” that the prospect is in; (c) the real estate requirement information (e.g., office lease); (d) a “Other Availabilities Matching This Prospect's Requirement:” section that shows a user a list of additional availability listings that a user owns that also match the prospect's real estate requirement or any other availability listings that are similar to the availability listing currently associated with the prospect wherein a prospect can be added to the prospect list of the additional availability listing by clicking the “Add to Prospect List” button; and (e) a “Send Email” icon so that the user can email the prospect information and log an activity into associated with the prospect (for an exemplary embodiment see FIG. 16). In the “Log activity for the following availabilities” section of the email pane, the system can automatically check-off the availability listing that is associated with the prospect, so that the user can quickly log an activity. Alternatively, the user can uncheck this, so that no activity is logged. Finally, the “Log activity for other matching availabilities” section can includes checkboxes that allow the user to simultaneously log an activity for other availability listings that are similar or that match the prospect's real estate requirements.

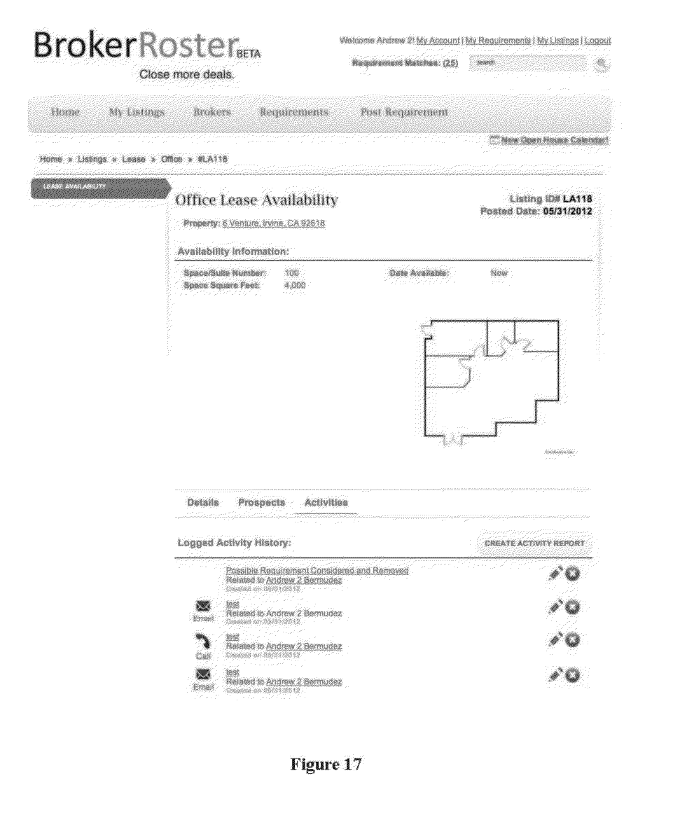

An “Activities” section can show a user a history record of all of the logged activities with various prospects as illustrated in FIG. 17 as an exemplary embodiment. In the activities section a user can edit or delete an activity and/or click the “Create Activity Report” button to create a report of all the logged activities. The activity report can downloaded as a MS Excel, MS Word, PDF and/or Web Page report.

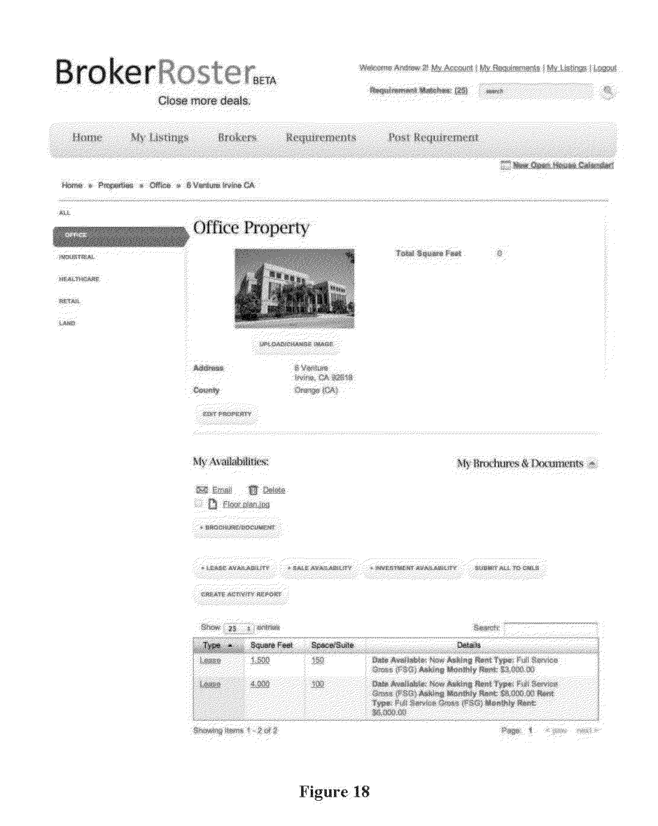

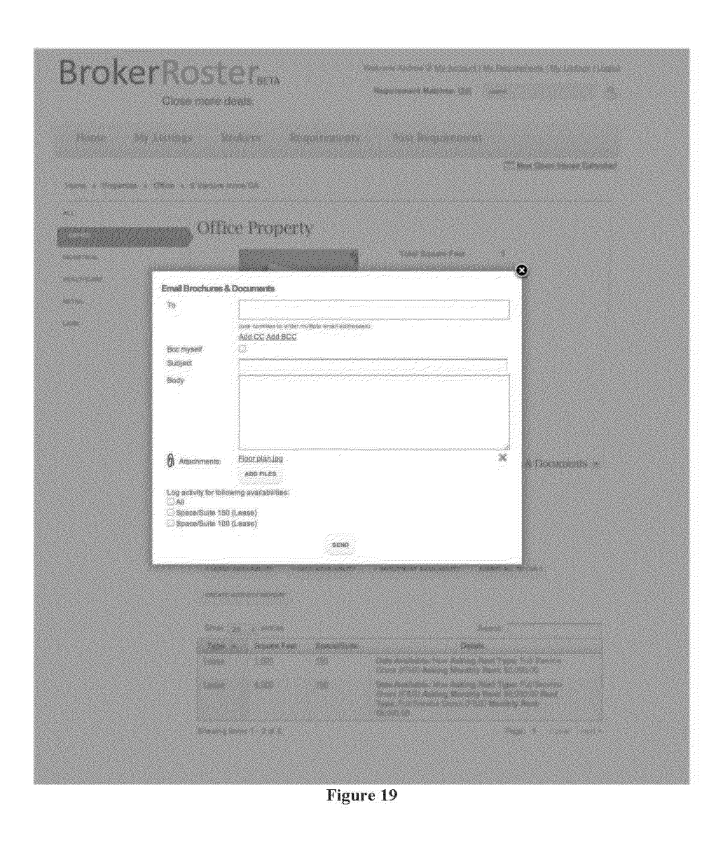

A property profile page can allow a user to see all of the currently active availability listings a user has associated with a property. An exemplary embodiment of a property profile page is illustrated in FIG. 18. It is contemplated that a user in a property profile page can: (1) create new availability listings available for lease, sale and investment; (2) submit various active availability listings to the commercial multiple listing services (MLS) by clicking the “Submit to All CMLS” button; and (3) create a report for all the activities under each one of their active availability listings associated with the property by clicking the “Create Activity Report”. The user can select what availabilities the user would like to create an activity report for. Additionally, the activity report can be downloaded as a MS Excel, MS Word, PDF and/or Web Page report. A “My Brochures and Documents” section in the property profile page can allow a user to upload and manage files, documents and brochures associated with their active availability listings associated with a property. Furthermore, it is contemplated that the user can share and email these files directly through the Property Profile Page by clicking the “Email” link/icon as illustrated in FIG. 19 in an exemplary embodiment. Finally, the user can select the availability listing that they would like to log an activity in the activity when sending an email under a “Log Activity for following availabilities” section. The system can also automatically create a prospect associated with the availability if the email address entered doesn't match a prospect that is already associated with the availability listing the user is logging an activity for.

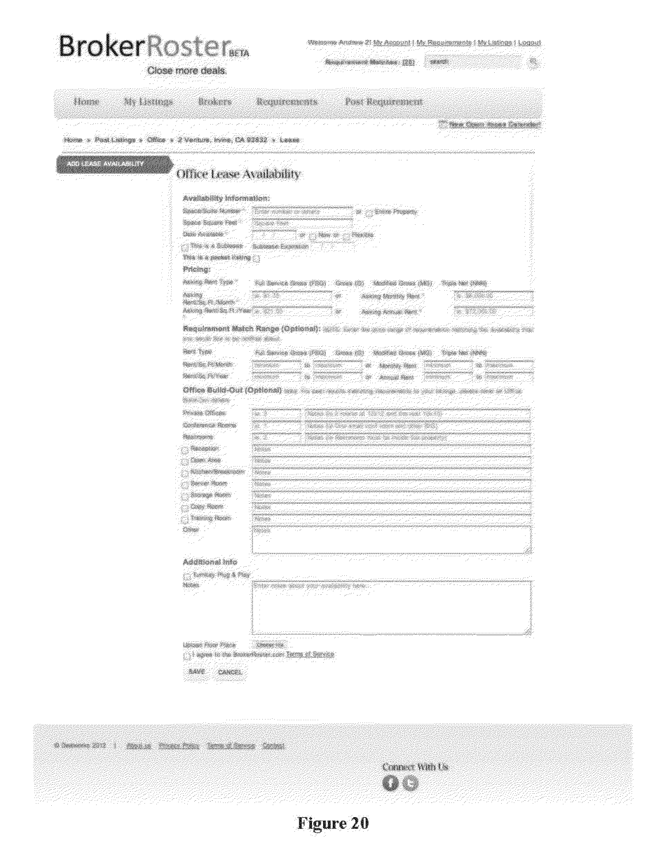

FIG. 20 is an exemplary embodiment of a form to create an available listing. When a user decides to create an availability, the availability form presented to the user can differ based on the type of property and the type of availability listing the user has selected to create. The form allows the user to enter the various details associated with the availability. Additionally, a user can mark whether an availability listing is a “Pocket Listing”, so that the availability listing will not be viewed by other users nor submitted to the multiple listing services. Furthermore, the user is able to create a “Requirement Match Range”, which is used to calibrate the matching of all the posted real estate requirements if they don't match the pricing located in the “Pricing” section of the form. It is further contemplated that the user can enter the details of the tenant improvement floor plan/office build-out. The user can upload various floor plan images associated with the availability being created. As soon as the availability listing is created, the system can automatically show all of the real estate requirements posted by other users in the system that match. The system can also automatically show all of the “Prospects” created by the user that are associated with similar availability listings or that have added real estate requirements that match the availability listing that was just created.

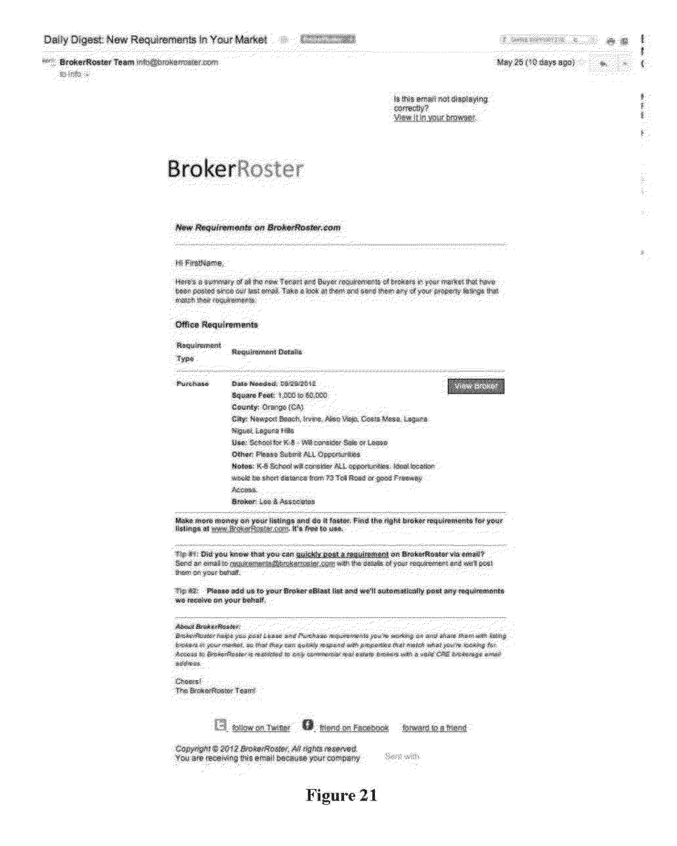

Finally, it is contemplated that an email can be sent out to all registered users and list in the “Master Database of Possible Users”, which summarizes all of the real estate requirements posted by users in their market. An illustrative embodiment of such email can be shown in FIG. 21.

Throughout the above discussion, numerous references are made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system having a processor that cooperates with a database, programmed to facilitate commercial real estate transactions by providing:
a first electronic interface through which a first broker can post real estate requirements;
a second electronic interface through which a second broker can post real estate availabilities;
a facility that finds a match among the requirements and the availabilities, and notifies at least one of the first and second brokers of the match.

2. The system of claim 1, wherein the match is on based deal terms, type of real estate, and timing.

3. The system of claim 1, wherein the match is based on logic that does not require exact matching of terms.

4. The system of claim 1, wherein a registration of the first broker with the system is vetted by a human administrator.

5. The system of claim 1, wherein the system recommends availability listings that match a current requirements listing.

6. The system of claim 1, wherein the system recommends requirements listings that match a current availability listing.

7. The system of claim 1, wherein the system logs activities, and generate an activity report with respect to at least one of a subset of clients, a subset of availability listings, and a subset of requirement listings

8. The system of claim 1, wherein the system automatically notifies relevant brokers upon entry of at least one of a new availability listing and a new requirement listing.

9. The system of claim 8, wherein notification to the relevant brokers is automatically limited to a particular company.

10. The system of claim 8, wherein notification to the relevant brokers is automatically limited to a particular subset of the relevant brokers.

11. The system of claim 1, wherein the system automatically notifies a multiple listing service (MLS) upon entry of a new listing.
